(19) United States
(12) Patent Application Publication
(10) Pub. No.: US 2010/0264386 A1
(43) Pub. Date: Oct. 21, 2010

(54) Pneumatic Apparatus For Use In Lifting And Installing Garbage Disposers

(76) Inventor: Steven G. Dvorak, Houston, TX (US)

Correspondence Address: CLARENCE E. ERIKSEN & ASSOCIATES, P.C., 1415 SOUTH VOSS ROAD, SUITE 110-440, HOUSTON, TX, 77057, US

(21) Appl. No.: 12/757,014

(22) Filed: Apr. 8, 2010

Related U.S. Application Data
(60) Provisional application No. 61/169,975, filed on Apr. 16, 2009.

(51) Int. Cl. B66F 3/35

(52) U.S. Cl. 254/93 HP; 254/93 R

(57) ABSTRACT

Pneumatic apparatus is disclosed for installing a garbage disposer under a kitchen sink which comprises a base structure and an inflatable, air-tight bellows which is attached to the top of the base structure. The bellows is expandable between a deflated position and an inflated position. Pneumatic apparatus in accordance with the present invention comprises inflation/deflation apparatus which is disposed in the base structure for supplying air to the bellows to permit it to expand to its inflated position and for removing air from the bellows to permit the bellows to contract to its deflated position. A platform is provided which is attached to the top of the bellows for receiving the garbage disposer which is to be installed.

### CROSS-REFERENCE TO RELATED APPLICATION

The present application claims the benefit of the filing date of U.S. Provisional Application No. 61/169,975 Filed Apr. 16, 2009.

### BACKGROUND OF THE INVENTION

1. Field of the Invention

The present invention relates to pneumatic apparatus for lifting and installing a garbage disposer.

2. Description of the Prior Art

A garbage disposer is a heavy, electrically-powered device which is installed under a kitchen sink between the sink's drain and the trap and which is used to shred food waste into pieces that are small enough to pass through plumbing. Garbage disposers are also sometimes designated as garbage disposals, food waste disposals, food waste disposers, and waste disposal units, and the term “garbage disposer” as used in this application is intended to refer to and embrace all such designations.

In order to install a garbage disposer under a kitchen sink, the garbage disposer must be lifted until it is properly situated in a mounting flange opening. Once the garbage disposer is properly situated in the mounting flange opening, a connector ring must be rotated to lock the garbage disposer in place.

This installation operation is difficult and usually requires at least two hands, because the garbage disposer must be maintained in a vertical orientation to be properly situated in the mounting flange opening. The installation is exacerbated by the fact the installer of the garbage disposer is kneeling or sitting outside of the cabinet containing the kitchen sink, and must lift the heavy garbage disposer with his/her arms extended. It is difficult for the installer to maintain the garbage disposer in a vertical orientation inside the cabinet from that kneeling or sitting position with his/her arms extended. Moreover, the combined operation of maintaining a vertical orientation and rotating the connector ring often requires a helper or some fashion of temporary support to maintain the positioning of the garbage disposer during installation.

Hydraulic jacks have been proposed to assist in the positioning of a garbage disposer during its installation. Conventional hydraulic jacks are, however, cumbersome, heavy, vertically unstable and still require two hands to operate, i.e. one to steady the garbage disposer and one to position and operate the hydraulic jack.

### SUMMARY OF THE INVENTION

In accordance with the present invention, pneumatic apparatus is provided for use in installing a garbage disposer under a kitchen sink. Pneumatic apparatus in accordance with the present invention comprises a base structure having a top and a bottom and a hollow interior portion. Pneumatic apparatus in accordance with the present invention further comprises an inflatable, air-tight bellows having a top and a bottom where the bottom of the bellows is attached to the top of the base structure. The bellows is expandable between a deflated position and an inflated position, and the bellows expands vertically from the top of the base structure when it is inflated. Pneumatic apparatus in accordance with the present invention further comprises inflation/deflation apparatus which is disposed in the hollow interior of the base structure for supplying air to the bellows to permit the bellows to expand to its inflated position and for removing air from the bellows to permit the bellows to contract to its deflated position. A platform is provided which is attached to the top of the bellows on which the garbage disposer to be installed may sit.

In one embodiment of pneumatic apparatus in accordance with the present invention, the inflation/deflation apparatus comprises a cylinder containing a compressed air, a filler valve for permitting air from the cylinder to enter the bellows to inflate the bellows, and a relief valve for permitting removal of air from the bellows to deflate the bellows. The cylinder may be a refillable cylinder, and, if so, pneumatic apparatus in accordance with the present invention comprises a valve for use in refilling the cylinder a compressed air.

In yet another embodiment of pneumatic apparatus in accordance with the present invention, the inflation/deflation apparatus comprises a tire valve inlet nozzle which is connected to the base structure and a hose which connects the tire valve inlet nozzle to the bellows. In this embodiment, the bellows may be inflated by connecting an external source of compressed air to the tire valve inlet nozzle, and the bellows may be deflated by depressing the valve stem in the tire valve inlet nozzle.

Pneumatic apparatus in accordance with the present invention may further comprise apparatus to facilitate its movement. In one embodiment, such apparatus comprises wheels which are affixed to the base structure proximate its bottom for moving the pneumatic apparatus. In yet another embodiment, glides may be affixed to the bottom of the base structure for moving the pneumatic apparatus

In one embodiment, the bellows of pneumatic apparatus in accordance with the present invention comprises a round bellows having a plurality of concentric circular sections which are fabricated from a inflatable, air-tight material which is joined at intervals of alternating greater and lesser diameters to permit vertical expansion and contraction of the bellows on the linear axis perpendicular to the circular segments. Such a bellows may advantageously be fabricated from a low density polyethylene material.

### BRIEF DESCRIPTION OF THE DRAWINGS

In the accompanying drawings:

FIG. 1 is a perspective drawing in partial cross-section of one embodiment of pneumatic apparatus in accordance with the present invention.

FIG. 2 is a perspective drawing in partial cross-section of another embodiment of pneumatic apparatus in accordance with the present invention.

FIG. 3 is a perspective drawing in partial cross-section which illustrates the use of pneumatic apparatus in installing a garbage disposer under a kitchen sink.

### DESCRIPTION OF THE SPECIFIC EMBODIMENTS

It will be appreciated that the present invention may take many forms and embodiments. In the following description, some embodiments of the invention are described and numerous details are set forth to provide an understanding of the present invention. Those skilled in the art will appreciate, however, that the present invention may be practiced without those details and that numerous variations and modifications from the described embodiments may be possible. The following description is thus intended to illustrate and not to limit the present invention.

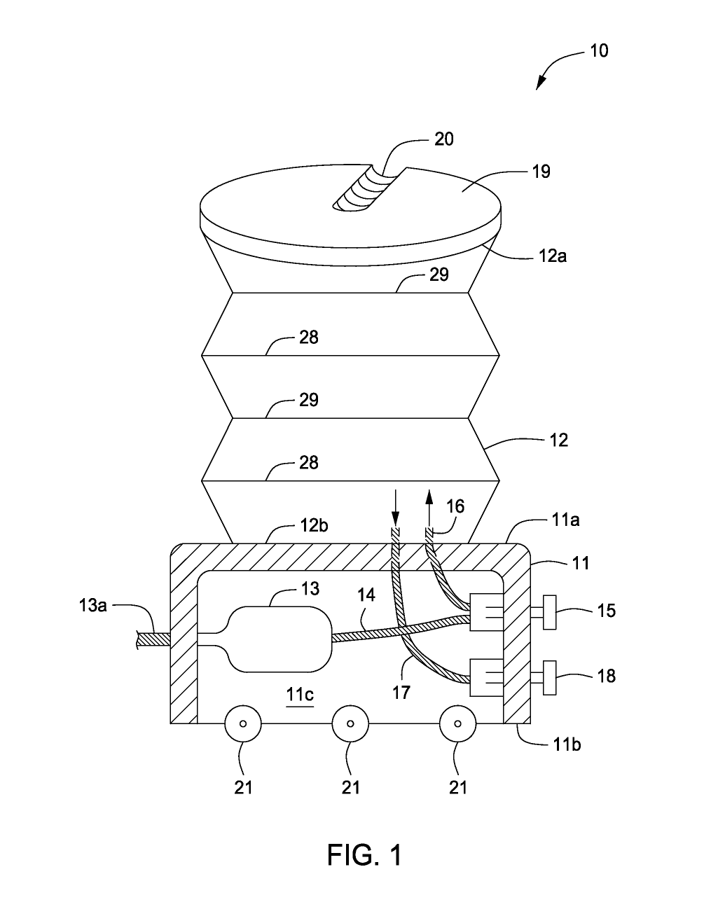

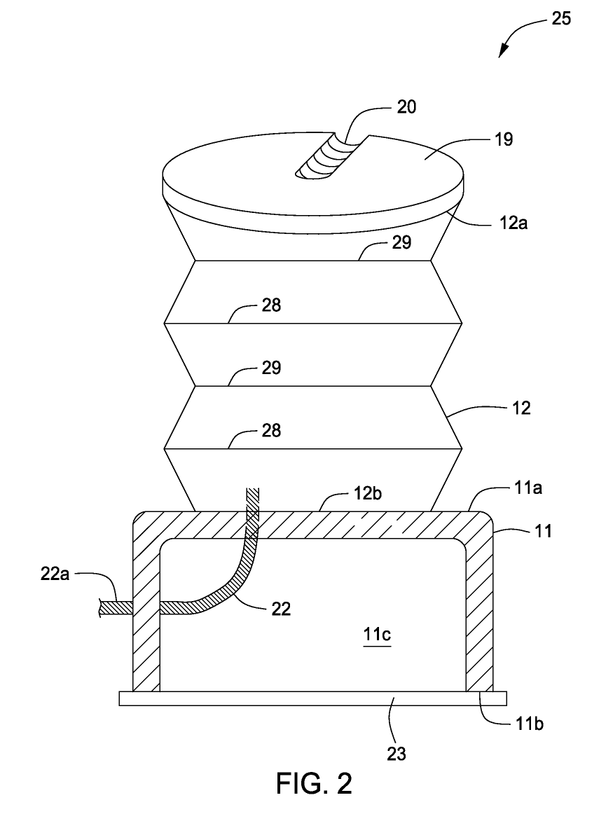

Referring first to FIGS. 1 and 2, pneumatic apparatus 10, 25 in accordance with the present invention comprises a base structure 11 having a top 11a and a bottom 11b and having a hollow interior 11c. Pneumatic apparatus 10 further comprises bellows 12 which has a top 12a and a bottom 12b and which is inflatable and air-tight. The bottom 12b of the bellows 12 is attached to the top 11a the base structure 11 and the bellows 12 is expandable between a deflated position and an inflated position (as illustrated in FIGS. 1 and 2). The bellows 12, when inflated, expands vertically from the top 11a of the base structure 11 and may, for example, be a round bellows comprising a plurality of concentric circular segments of a flexible, air-tight material joined at intervals of alternating greater and lesser diameters (diameters 28 and 29, respectively) to permit vertical expansion and contraction of the bellows on a linear axis perpendicular to the circular segments. The bellows 12 may advantageously be fabricated from low density polyethylene to sustain an inflation pressure of 4 psi.

Pneumatic apparatus 10, 25 in accordance with the present invention further comprises inflation/deflation apparatus which is disposed in the hollow portion of 11c of base structure 11 for supplying air to the bellows to permit the bellows to expand to its inflated position and for removing air from the bellows to permit the bellows to contract to its deflated position.

In the embodiment of the present invention illustrated in FIG. 1, the inflation/deflation apparatus of pneumatic apparatus 10 comprises cylinder 13 containing compressed air (which may be refillable via nozzle 13a), a filler valve 15, which when actuated, permits the compressed air from cylinder 13 to be supplied to bellows 12 via hoses 14 and 16. Bellows 12 may be deflated by actuating relief valve 18 which permits the removal of air from bellows 12 via hose 17. In the embodiment of the present invention illustrated in FIG. 2, the inflation/deflation apparatus of pneumatic apparatus 25 comprises tire valve inlet nozzle 22a which is connected to base structure 11 and hose 22 which provides air from the tire valve inlet nozzle 22a to the bellows. Air may be removed from bellows 12 in this embodiment by depressing the valve stem in tire valve inlet nozzle 22a.

With reference to both FIGS. 1 and 2, pneumatic apparatus 10, 25 in accordance with the present invention comprises a platform 19, which is attached to the top of bellows and which may, for example, be fabricated from a cushion material such as semi-rigid foam. The platform 19 has a groove or notch 20 formed therein.

Still referring to FIGS. 1 and 2, pneumatic apparatus 10, 25 in accordance with the present invention comprises apparatus to facilitate the movement of the pneumatic apparatus. In the embodiment of the present invention illustrated in FIG. 1, wheels 21 are affixed to the base structure 11 proximate its bottom 11b. In the embodiment of the present invention illustrated in FIG. 2, glides 23 are affixed to the base structure 11 proximate its bottom 11b. Those skilled in the art will appreciate that wheels 21 may be utilized with pneumatic apparatus 25 (FIG. 2) and that glides 23 may be utilized with pneumatic apparatus 10 (FIG. 1).

Pneumatic apparatus 10, 25 in accordance with the present invention will normally be seven to ten inches in diameter to accommodate conventional garbage disposers. Also, the pneumatic apparatus 10, 25 will normally have a height of approximately six inches when the bellows 12 is deflated and a height of approximately 14 inches when the bellows 12 is inflated.

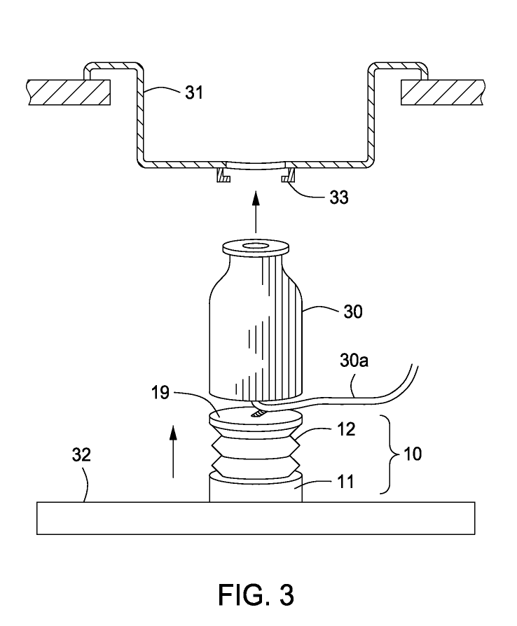

With reference now to FIG. 3, the operation of pneumatic apparatus in accordance with the present invention is discussed with respect to the pneumatic apparatus 10 of FIG. 1. The pneumatic apparatus 10 is placed on the base shelf 32 of the cabinet in which sink 31 is installed. If there is no base shelf, the pneumatic apparatus 10 may be placed on the floor beneath sink 31. The garbage disposer 30 to be installed is then placed on platform 19, and the electrical cord 30a associated with garbage disposer 30 fits into groove 20 of platform 19 to minimize any wobbling of the garbage disposer 30 during installation. The bellows 12 is then inflated, e.g., by actuating filler valve 15. Once the garbage disposer 30 snugly engages the mounting flange 33, the disposer ring is attached to the mounting flange 33. The relief valve 18 may then be actuated to deflate bellows 12, and the installation operation is complete.

What is claimed is:

1. Pneumatic apparatus for use in installing a garbage disposer under a kitchen sink, comprising:
a base structure comprising a top and a bottom and a hollow interior portion between the top and the bottom;
an inflatable, air-tight bellows comprising a top and a bottom, where the bottom of the bellows is attached to the top of the base structure, where the bellows is expandable between a deflated position and an inflated position and where the bellows expands vertically from the top of the base structure when inflated;
a platform which is attached to the top of the bellows; and
inflation/deflation apparatus disposed in the hollow interior of the base structure for (i) supplying air to the bellows to permit the bellows to expand to its inflated position and (ii) removing air from the bellows to permit the bellows to contract to its deflated position.

2. The pneumatic apparatus of claim 1, wherein the inflation/deflation apparatus comprises a cylinder containing compressed air, a filler valve for permitting air from the cylinder to enter the bellows to inflate the bellows, and a relief valve for permitting removal of air from the bellows to deflate the bellows.

3. The pneumatic apparatus of claim 2, wherein the cylinder is refillable and comprises a valve for use in refilling the cylinder with compressed air.

4. The pneumatic apparatus of claim 1, wherein the inflation/deflation apparatus comprises a tire valve inlet nozzle which is connected to the base structure and a hose which connects the tire valve inlet nozzle to the bellows.

5. The pneumatic apparatus of claim 1, further comprising wheels affixed to the base structure proximate its bottom for use in moving the pneumatic apparatus.

6. The pneumatic apparatus of claim 1, further comprising glides which are affixed to the base structure proximate its bottom for moving the pneumatic apparatus.

7. The pneumatic apparatus of claim 1, wherein the bellows is a round bellows comprising a plurality of concentric circular segments of a flexible, air-tight material joined at intervals of alternating greater and lesser diameters to permit vertical expansion and contraction of the bellows on a linear axis perpendicular to the circular segments.

8. The pneumatic apparatus of claim 1, wherein the inflatable, air-tight bellows is fabricated from low density polyethylene material.
